(19) United States
(12) Patent Application Publication
(10) Pub. No.: US 2007/0047132 A1
(43) Pub. Date: Mar. 1, 2007

(54) Method and apparatus for writing servo information

(75) Inventors: Hideo Sado, Ome-shi (JP); Masahide Yatsu, Akishima-shi (JP); Masafumi Iwashiro, Ome-shi (JP); Shouji Nakajima, Kodaira-shi (JP); Seiji Mizukoshi, Nishitama-gun (JP); Shinichirou Kouhara, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/447,981

(22) Filed: Jun. 7, 2006

(30) Foreign Application Priority Data
Aug. 31, 2005 (JP) 2005-251039

(51) Int. Cl. G11B 5/58

(52) U.S. Cl. 360/77.01

(57) ABSTRACT

According to one embodiment, a servo write method for writing servo information to a disk medium used in a disk drive is disclosed. In the procedure of the servo write method, first servo information is spirally written to a disk medium in a clean room before the disk medium is incorporated into the disk drive, then, the disk medium is incorporated into the disk drive, and second servo information is concentrically written to the disk medium already incorporated in the disk drive.

### CROSS-REFERENCE TO RELATED APPLICATIONS

This application is based upon and claims the benefit of priority from Japanese Patent Application No. 2005-251039, filed Aug. 31, 2005, the entire contents of which are incorporated herein by reference.

### BACKGROUND

1. Field

One embodiment of the invention relates to a servo write method for writing servo information to a disk medium incorporated in a disk drive, and more particularly to a self-type servo write method.

2. Description of the Related Art

In general, in disk drives represented by hard disk drives, servo information used for head-positioning control is recorded on a disk medium as a data recording medium. Using servo information read by a head, the head is positioned to a target position (target track) on the disk medium.

At the target position to which the head is positioned, the head writes or reads data. In general, the head includes a read head element and write head element, and reads data (including servo information) using the read head element and write data using the write head element.

The disk-drive-manufacturing process includes a servo write process (servo track write process) for recording servo information on a disk medium. The servo write process performed in a clean room mainly employs two methods—a write method for writing servo information to a disk medium using a dedicated servo information write apparatus (servo track writer), and a self-type servo write method for writing servo information to a disk medium incorporated into a disk drive, using the disk drive. In recent years, the self-type servo write method, which is superior in the accuracy of servo information, has been widespread.

In the self-type servo write method, a method has been proposed in which base servo information is recorded on a disk medium before the medium is incorporated into a disk drive, and new servo information is written based on the base servo information, after the medium is incorporated into the disk drive (see, for example, Jpn. pat. Appln. KOKAI Publication No. 2005-25826). The base servo information is written to the disk medium by a servo track writer in a clean room, before the medium is incorporated into the disk drive.

Another method has been proposed in which a spirally written, patterned medium is prepared, and servo information is spirally written to a disk medium based on the patterned medium (see, for example, Jpn. pat. Appln. KOKAI Publication No. 11-45528).

In the disk-drive-manufacturing process, the time required for the servo write process for recording servo information is a factor of reducing the efficiency of the entire manufacturing process. In particular, in order to enhance the efficiency of the servo write process, it is important to shorten the time required to write servo data using a servo track writer in a clean room.

In disk drives, in general, servo information is recorded concentrically on a disk medium. Compared to the concentrically recorded servo information, spirally recorded servo information employed in the above-mentioned method can be written to the entire surface of a disk medium in a shorter time, since it requires no head stop time.

However, in disk drives on the market, when user data (computer data, or stream data such as video data) is written to concentric data tracks on a disk medium, using a head, it is necessary for the head to read servo information when it is on a target track, and to be accurately positioned. Namely, in disk drives in which data is recorded on concentric data tracks on a disk medium, the servo information recorded on the disk medium must be concentrically written servo information. In other words, in the case of using spirally written servo information, the head positioning accuracy is relatively reduced.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating a disk drive according to an embodiment of the invention;

FIGS. 2A and 2B are views useful in explaining the features of first and second servo information items employed in the embodiment;

FIG. 3 is a view illustrating each sector data item contained in the first and second servo information items of the embodiment;

FIGS. 4A and 4B are developments corresponding to FIGS. 2A and 2B, respectively;

FIG. 5 is a flowchart useful in explaining the procedure of a servo write method employed in the embodiment;

FIG. 6 is a flowchart useful in explaining the procedure of writing first servo information employed in the embodiment;

FIG. 7 is a view useful in explaining a method for writing first servo information employed in the embodiment;

FIGS. 8A and 8B are views useful in explaining a method for writing second servo information employed in the embodiment;

FIG. 9 is a flowchart useful in explaining the procedure of writing second servo information employed in the embodiment; and

FIG. 10 is a graph useful in explaining an amount of correction for positional information performed when the second servo information is written.

### DETAILED DESCRIPTION

Various embodiments according to the invention will be described hereinafter with reference to the accompanying drawings. In general, according to one embodiment of the invention, the servo write method is used, in a disk drive into which a head and a disk medium are incorporated, for writing, to the disk medium, servo information used to achieve positioning control of the head. The method comprises: writing, to an entire surface of the disk medium, first servo information including a plurality of sectors arranged at regular intervals in a circumferential direction of the disk medium, the first servo information defining a spiral track; and writing second servo information to the disk medium with the first servo information written thereon, based on the first servo information, the second servo information including a plurality of sectors arranged at regular intervals in the circumferential direction of the disk medium, the second servo information defining concentric tracks.

[Configuration of Disk Drive]

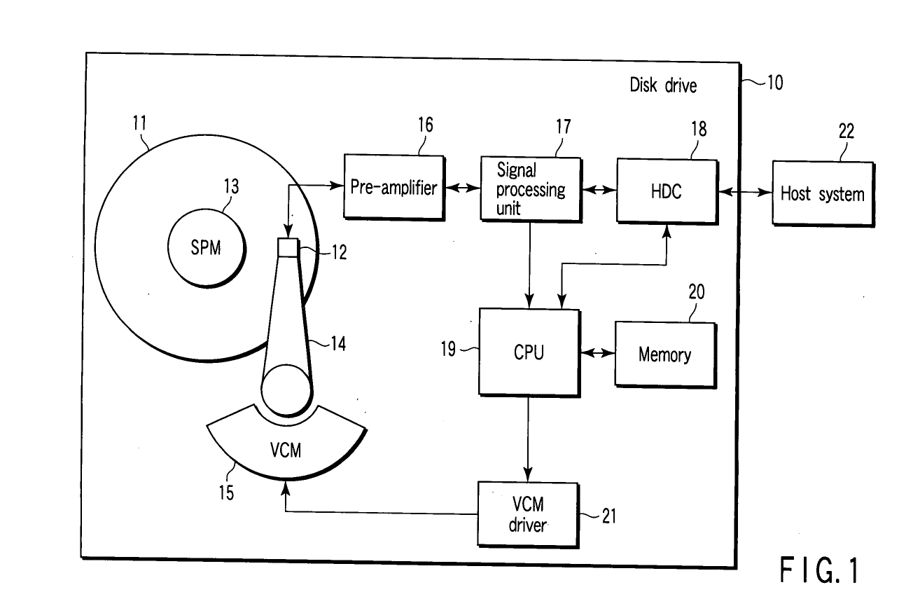

FIG. 1 is a block diagram illustrating a disk drive 10 according to the embodiment of the invention.

The disk drive 10 of the embodiment is a hard disk drive using a disk medium 11 as a magnetic recording medium. First servo information is spirally written to the disk medium 11, using a servo track writer, before the disk medium 11 is incorporated into the disk drive 10. The disk medium 11 with the first servo information is incorporated into the disk drive 10, secured to a spindle motor (SPM) 13 to be spun at high speed.

The disk drive 10 comprises a head 12 including a read head element for reading data (servo information and user data) from the disk medium 11, and a write head element for writing data to the medium 11. Hereinafter, the read and write head elements may be referred to simply as the head 12. The head 12 is mounted on an actuator 14 driven by a voice coil motor (VCM) 15.

The VCM 15 is powered by a driving current supplied from a VCM driver 21. The actuator 14 is a head moving mechanism controlled by a microprocessor (CPU) 19, described later, for positioning the head 12 at a target position (target track) on the disk medium 11.

In addition to the above-mentioned head/disk assembly, the disk drive 10 comprises a pre-amplifier circuit 16, signal processing unit 17, disk controller (HDC) 18, CPU 19 and memory 20.

The pre-amplifier circuit 16 includes a read amplifier for amplifying a read data signal output from the read head incorporated in the head 12, and a write amplifier for supplying a write data signal to the write head of the head 12. Namely, the write amplifier converts, into a write current signal, the write data signal output from the signal processing unit 17, and supplies it to the write head.

The signal processing unit 17 is a circuit for performing various types of signal processing, and is also called a read/write channel.

The HDC 18 functions as an interface between the drive 10 and a host system 22 (e.g., a personal computer or digital device). More specifically, the HDC 18 controls the transfer of read/write data between the disk 11 and host system 22.

The CPU 19 is a main controller in the drive 10, and controls a self-type servo write operation according to the embodiment, and standard user-data read/write operations performed after the disk drive 10 is manufactured. The memory 20 includes a RAM, ROM, etc., as well as a flash memory (EEPROM) as a nonvolatile memory, and stores various data and programs necessary for the CPU 19 to perform various types of control.

(Servo Write Process)

Referring mainly to the flowcharts of FIGS. 5, 6 and 9, a description will be given of the procedure of a servo write method for writing servo information to the disk medium 11.

Firstly, the entire procedure of the servo write operation will be described referring to the flowchart of FIG. 5.

Before incorporating the disk medium 11 into the disk drive 10, the medium 11 is sent to a clean room. In the clean room, first servo information (spirally written servo information) is written to substantially the entire surface of the disk medium 11, using a servo track writer (step S1). Subsequently, the disk medium 11 with the first servo information is attached to the spindle motor 13 of the disk drive 10 in the assembly process of the disk drive 10 (step S2).

In the assembly process of the disk drive 10, the circuits such as the head 12 and CPU 19, other than the disk medium 11, are firstly assembled. After that, second servo information (concentrically written servo information) is written to the disk medium 11 (step S3). More specifically, the CPU 19 of the disk drive 10 activates a servo-write-execution program stored in the memory 20, thereby executing the processing of writing the second servo information to the disk medium 11.

When writing the first servo information to the disk medium 11, a dedicated servo information write device of a magnetic transfer system may be used instead of the servo track writer. Further, the first servo information may be written to the disk medium 11 in the clean room, using a pushpin-type servo track writer, after the medium 11 is incorporated into the disk drive 10. The pushpin-type servo track writer operates the head 12 in the disk drive 10 to write the first servo information to the disk medium 11.

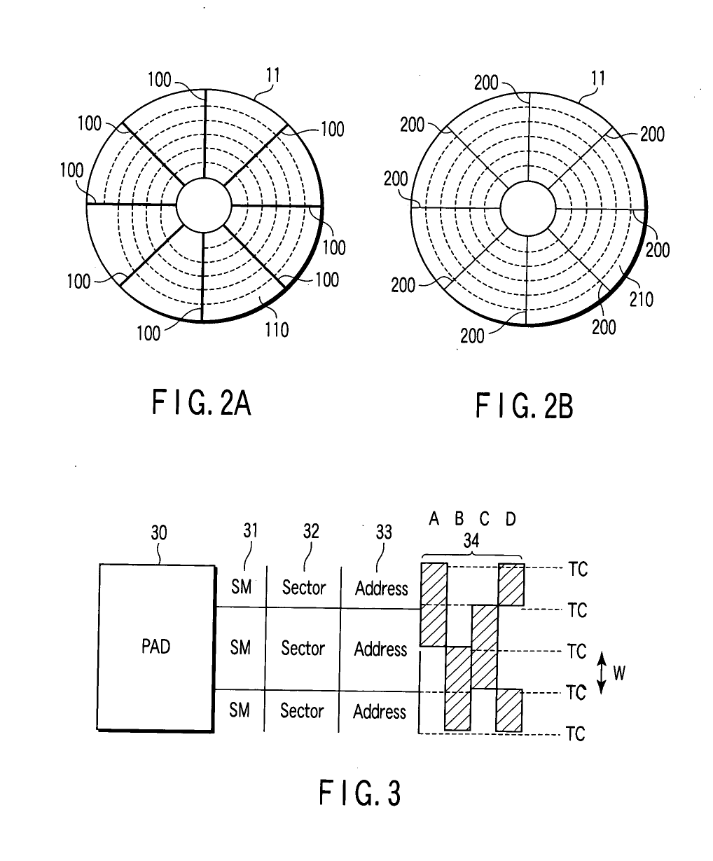

Referring then to the flowcharts of FIGS. 6 and 9, and FIGS. 2 to 4, 7 and 8, the writing procedure of each of the first and second servo information items will be described.

The features of the first and second servo information items will firstly be described, referring to FIGS. 2A and 2B.

As shown in FIG. 2A, the first servo information is written to the disk surface to define a so-called spiral track thereon. In contrast, as shown in FIG. 2B, the second servo information is written to the disk surface to define concentric tracks thereon.

Both the first and second servo information items are sector servo information items that each have such a servo pattern as shown in FIG. 3, in which servo data is written to each sector (servo sector) arranged at regular intervals in the circumferential direction of the disk medium 11.

Specifically, the first servo information comprises servo data recorded in a plurality of servo sectors 100 included in the spiral track 110, as shown in FIG. 2A. Similarly, the second servo information comprises servo data recorded in a plurality of servo sectors 200 included in each of the concentric tracks 210, as shown in FIG. 2B.

As shown in FIG. 3, the servo data recorded in each servo sector 100, 200 is, for example, amplitude-detection-type servo pattern data, which comprises a pad (PAD) section 30, servo mark (SM) section 31, sector section 32, address section 33 and servo burst pattern section 34. In FIG. 3, reference symbol TC denotes the track center. Reference symbol W denotes half the track width, and corresponds to the forward amount of the head 12 advanced while the disk medium 11 is rotated by one rotation (through 360 degrees) during the writing of the first servo information.

The pad section 30 includes a synchronization signal region called a gap and servo AGC. The servo mark section 31 is a signal region for identifying the servo sector. The sector section 32 is a record region that stores a sector code for identifying the position of the servo sector on the disk medium 11. The address section 33 is a record region that stores a track code (cylinder code) indicating the track (cylinder) of the servo sector. The servo burst pattern section 34 stores burst signals A to D used to detect the position of the head 12 in the track.

In the embodiment, the servo mark section 31, for example, stores information for identifying the first and second servo information items. When the head 12 reads servo information from the disk medium 11, the CPU 19 determines, from the servo mark section 31 included in the read servo information, whether the read servo information is the first or second servo information.

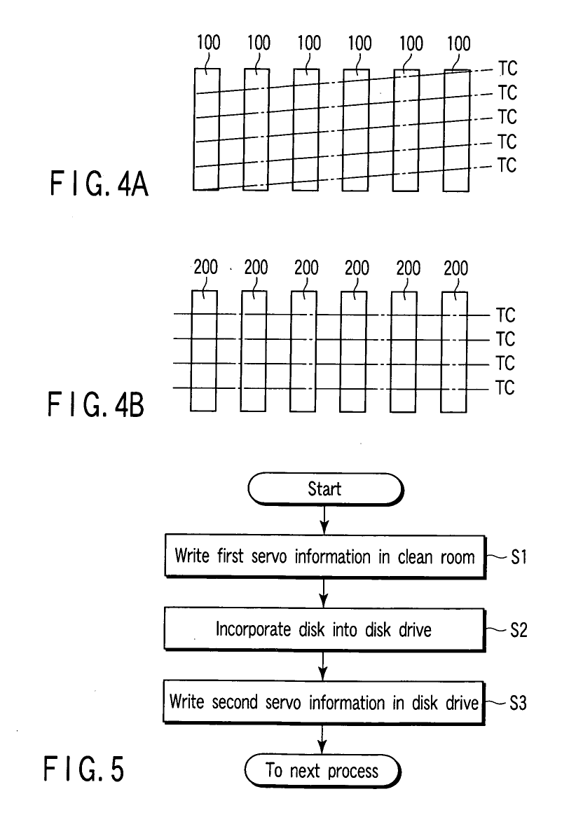

FIGS. 4A and 4B are developments of FIGS. 2A and 2B, respectively.

In the first servo information, if track center TC positions between pairs of adjacent servo sectors 100 are connected, a spiral locus is acquired as shown in FIG. 4A. In contrast, in the second servo information, if the positions of the track center TC between pairs of adjacent servo sectors 200 are connected, concentric tracks are acquired as shown in FIG. 4B.

(Write Procedure of First Servo Information)

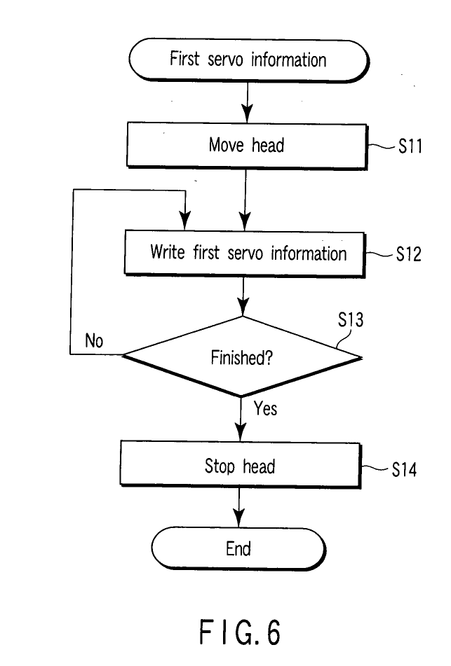

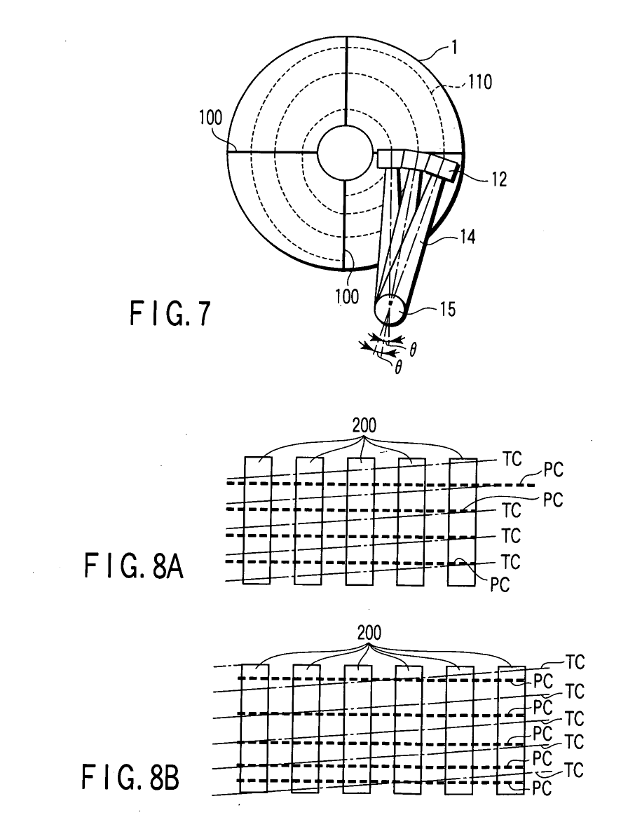

Referring to FIGS. 6 and 7, the write procedure of the first servo information will be described.

As described above, in the embodiment, the first servo information is written to the entire surface of the disk medium 11 in a clean room, using the servo track writer. At this time, the servo track writer moves the write head to the outer periphery of the disk medium 11, and writes first servo information 100 while moving the head radially inwardly (steps S11 and S12).

If the servo track writer writes the first servo information to the disk medium 11 before the medium 11 is incorporated into the disk drive 10, it uses a dedicated write head. In contrast, if the servo track writer writes the first servo information in a clean room to the disk medium 11 incorporated in the disk drive 10, it operates the head 12 of the disk drive 10 as shown in FIG. 7.

In any case, the servo track writer writes the first servo information to the entire surface of the disk medium 11 to define the spiral track 110 thereon, while controlling the head so as to move the rotary actuator with the head mounted thereon through angle θ per unit time. FIG. 7 shows the case where the servo track writer writes the first servo information 100 using the disk drive 10, while controlling the movement of the head 12 so as to move the rotary actuator with the head mounted thereon through angle θ per unit time. This head movement control enables the angular velocity of the rotary actuator 14 to be kept constant during writing, whereby the first servo information can be written with high writing accuracy.

The servo track writer writes the first servo information up to the innermost surface portion of the disk medium 11, without stopping the movement of the write head (e.g., the head 12) (step S13). After finishing the write operation (Yes at step S13), the servo track writer stops the movement of the write head (step S14).

As described above, in the embodiment, when the first servo information is written to the disk medium 11 in a clean room, the servo information write operation is performed to define the spiral track 110. This write method can significantly reduce the time required for writing, compared to the conventional servo information write operation performed to define concentric tracks.

More specifically, in the servo information write operation performed to define concentric tracks, it is necessary to stop the head at a preset radial position on the disk medium 11. Namely, the movement (seeking operation) of the head, the stop of the movement of the head, and the write operation by the head are iterated for defining the tracks. The operation performed to stop the movement of the head is a factor that increases the time required to write servo information.

In contrast, in the first servo information write method employed in the embodiment to define the spiral track 110, writing is performed with the head kept moving, to define a spiral, i.e., continuous track, as is shown in FIG. 2A. As a result, the servo information write time can be reduced by the time for which the head is stopped during the write process.

(Write Procedure of Second Servo Information)

Referring then to FIGS. 8 and 9, the write procedure of the second servo information will be described.

As described above, in the servo write method of the embodiment, the disk drive 10 writes the second servo information to the disk medium 11 with the first servo information 100 already recorded thereon in a clean room. The write control operation of the CPU 19 of the disk drive 10 will now be described. The servo data (see FIG. 3) necessary for the writing of the second servo information is generally supplied from a host system (computer) 22 connected to the HDC 18 of the disk drive 10.

Firstly, the CPU 19 moves the head 12 to, for example, the innermost portion of the disk medium 11 to read the first servo information 100 using the read head element of the head 12 (step S21). Based on the read first servo information 100, the CPU 19 executes position computation to compute the position of the head 12. More specifically, the track address and servo burst pattern (A to D) contained in the first servo information are reproduced by the signal processing circuit 17 and then supplied to the CPU 19. The CPU 19 detects the track position from the track address, and detects the head position in the track range from the servo burst pattern (A to D).

As mentioned, the first servo information 100 corresponds to the spiral track 110. On the other hand, the CPU 19 writes, to the disk medium 11, second servo information 200 corresponding to the concentric tracks 210. To this end, the CPU 19 executes position correction computation for correcting the position information, acquired from the first servo information 100, based on preset imaginary concentric tracks (200) (step S22). The CPU 19 executes the position correction computation, referring to a preset expression for computation or position correction table information prestored in the memory 20.

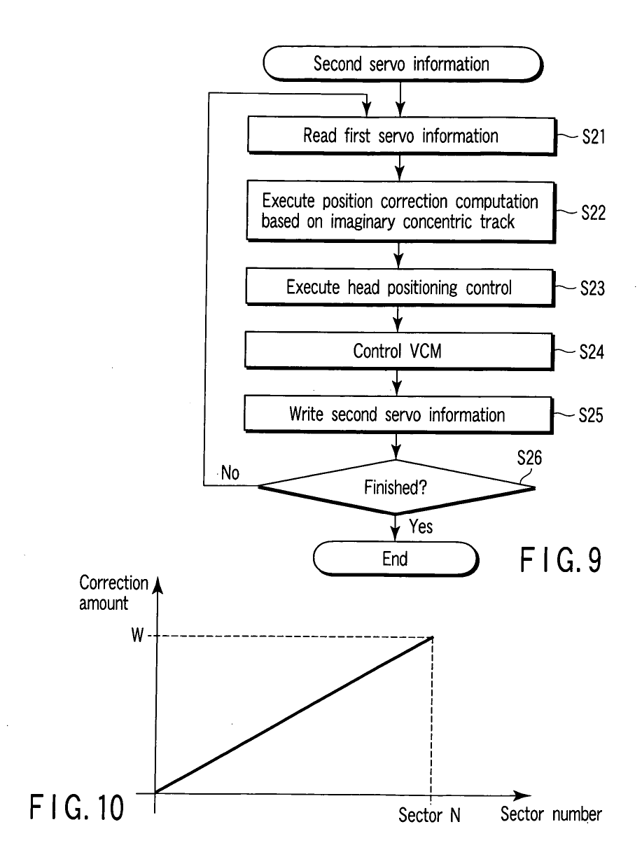

FIG. 10 shows a correction amount corresponding to each servo sector and used for the position correction computation (step S22). The first servo information is written so that the track center position TC is displaced by half the track width (corresponding to W in FIG. 3) each time the disk medium 11 is rotated through 360 degrees. Accordingly, assuming that N servo sectors are written by the disk drive 10, it is sufficient if when the servo sector number is 0, the amount of correction is set to 0, and when the servo sector number is N-1, the amount of correction is set to W(N-1)/N. The amount of correction may be determined referring to position correction table information corresponding to FIG. 10, or using a correction expression that indicates the characteristic of FIG. 10.

Specifically, the amount x of correction can be acquired using equation x=W×k/N (k indicates the servo sector number). In any method, the amount of correction can be determined by reading sector information 32 contained in a servo pattern. The position correction computation is actually the operation of subtracting the amount of correction from the position information acquired at step S21.

The CPU 19 iterates the above-described write operations while moving the head 12 from the innermost portion of the disk medium 11 to the outermost portion (step S26). The CPU 19 writes the second servo information while stopping the head 12 each time the head 12 reaches a preset radial position on the disk medium 11. As a result, the second servo information is written to define concentric tracks 210 on the entire surface of the disk medium 11 as shown in FIG. 2B.

FIGS. 8A and 8B are views illustrating the positioning loci of the write head assumed when writing the second servo information 200.

When servo information is written with the same track pitch (width) as the first servo information, the write head is made to assume the locus PC shown in FIG. 8A, thereby writing the second servo information 200 that defines concentric tracks of a single pitch.

On the other hand, when servo information is written with different track pitches, the write head is made to assume the locus PC shown in FIG. 8B, thereby writing the second servo information 200 that defines concentric tracks of different pitches. Namely, where a data track (track range except for servo sectors) corresponding to, for example, 10 tracks is defined on the disk medium 11 by the already written first servo information, the CPU 19 can define, for example, 20 data tracks by writing the second servo information 200 that defines concentric tracks with the track pitch adjusted. In this case, since the first servo information 100 is written by moving the actuator at a constant angular velocity as shown in FIG. 7, it is written at regular intervals in the radial direction on the disk medium 11.

Since the first circuit of the positioning locus PC always covers the track center TC of the first servo information and a track portion off the track center TC, first servo information of the same characteristic can be acquired when the second servo information is written, regardless of whether the second servo information is written with a single track pitch or different track pitches. Also for this reason, it is preferable to make the first servo information define a spiral track, when the second servo information is written with different track pitches.

As described above, in the servo write method of the embodiment, the first servo information is written to the disk medium 11 in a clean room to define the spiral track 110, therefore the time required for writing can be significantly reduced.

In addition, in the disk drive 10, the second servo information 200 for defining concentric tracks 210 can be reliably written to the disk medium 11 by positioning the head 12 based on the first servo information 100.

Accordingly, in the shipped disk drive 10, when user data is written to the concentric data tracks on the disk medium 11, head positioning control can be executed based on the second servo information 200 defining the concentric tracks. That is, when user data is written, the head 12, which is on a target track, reads the second servo information 200 for the execution of positioning control. As a result, highly accurate head positioning is realized. In contrast, if the first servo information 100 defining the spiral track is used to perform head positioning control on concentric data tracks, head positioning control will be executed while the head is not on a target track.

An erasure process may be provided for erasing the first servo information 100 from the disk medium 11 after the second servo information 200 is written. Alternatively, since the CPU 19 executes head positioning control based on the second servo information when user data is read or written, using information for discriminating the first and second servo information items from each other, the first and second servo information may be kept recorded on the disk medium 11. In this case, when user data is written, part of the first servo information may be erased by overwriting.

In conclusion, in the embodiment, first servo information defining a spiral track is written to a disk medium in, for example, a clean room, therefore the time required for writing servo data can be relatively reduced. Furthermore, since second servo information defining concentric data tracks is written to the disk medium to be incorporated into a disk drive, highly accurate head positioning control can be realized.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method, for use in a disk drive into which a head and a disk medium are incorporated, for writing, to the disk medium, servo information used to achieve positioning control of the head, the method comprising:
writing, to an entire surface of the disk medium, first servo information including a plurality of sectors arranged at regular intervals in a circumferential direction of the disk medium, the first servo information defining a spiral track; and
writing second servo information to the disk medium with the first servo information written thereon, based on the first servo information, the second servo information including a plurality of sectors arranged at regular intervals in the circumferential direction of the disk medium, the second servo information defining concentric tracks.

2. The method according to claim 1, wherein in the writing the first servo information, the first servo information is written to the disk medium using a dedicated servo information writing unit, before the disk medium is incorporated into the disk drive.

3. The method according to claim 1, wherein in the writing the second servo information, the second servo information is written to the disk medium using the head incorporated in the disk drive, after the disk medium with the first servo information written thereon is incorporated into the disk drive.

4. The method according to claim 1, wherein the writing the second servo information includes:
reading the first servo information from the disk medium, using the head;
executing position correction computation for correcting head position information computed from the first servo information read by the head, based on imaginary concentric tracks corresponding to the concentric tracks;
executing head positioning control based on the head position information corrected by the position correction computation; and
writing the second servo information to positions determined by the head positioning control.

5. The method according to claim 4, wherein in the executing the position correction computation, the position correction computation is executed based on the imaginary concentric tracks, using a preset computation expression or preset table information.

6. The method according to claim 1, wherein in the writing the second servo information, the second servo information is written to the disk medium in the defined concentric tracks with a designated track pitch.

7. The method according to claim 1, wherein the first or second servo information contains identification information.

8. A disk drive comprising:
a head;
a disk medium with first servo information recorded thereon, the first servo information being used for head positioning control and including a plurality of sectors arranged at regular intervals in a circumferential direction of the disk medium, the first servo information defining a spiral track;
a spindle motor which rotates the disk medium;
an actuator which moves the head;
a head positioning control unit which controls the actuator to execute the head positioning control based on the first servo information read by the head; and
a servo write unit which writes second servo information to the disk medium to define concentric tracks, while the head is moved by the head positioning control unit, the second servo information including a plurality of sectors arranged at regular intervals in the circumferential direction.

9. The disk drive according to claim 8, wherein the head positioning control unit executes position correction computation for correcting head position information computed from the first servo information read by the head, based on imaginary concentric tracks corresponding to the concentric tracks, and executes the head positioning control based on the head position information corrected by the position correction computation.

10. The disk drive according to claim 8, wherein the head positioning control unit and the servo write unit are formed of a microprocessor.

11. The disk drive according to claim 9, wherein the head positioning control unit is formed of a microprocessor which executes the position correction computation, and executes the head positioning control based on the head position information corrected by the position correction computation.

12. The disk drive according to claim 8, wherein:
the head positioning control unit and the servo write unit are formed of a microprocessor;
the first or second servo information contains identification information; and
the microprocessor identifies the second servo information read by the head from the disk medium which records both the first servo information and the second servo information, and executes the head positioning control based on the second servo information read by the head, when user data is written to or read from the disk medium.
